(19) United States
(12) Patent Application Publication
(10) Pub. No.: US 2009/0198589 A1
(43) Pub. Date: Aug. 6, 2009

(54) SEEDED CARRIER AND CUSTOMIZED FUNDRAISING ITEMS INCLUDING THE SAME

(76) Inventor: George A. Castineiras, Farmington, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 12/024,510

(22) Filed: Feb. 1, 2008

(51) Int. Cl. G06Q 30/00; B65D 85/50

(52) U.S. Cl. 705/26; 705/1

(57) ABSTRACT

A carrier for use in conducting a fundraiser is presented. The carrier including a first layer having a plurality of seeds disposed therein or thereon, a second layer disposed over the plurality of seeds and at least a portion of the first layer, and customizable postage indicia disposed on the first layer. The plurality of seeds and the customizable postage indicia have relevance to the fundraiser. In one embodiment, the first layer is comprised of a biodegradable material that gradually disintegrates when exposed to moisture. When the biodegradable material disintegrates the plurality of seeds germinate over time and develop into a desired organic matter. In one embodiment, the desired organic matter includes at least one of plants bearing flowers, fruit, vegetables, herbs, trees and the like.

### CROSS-REFERENCE TO RELATED APPLICATIONS

This patent application relates to U.S. Provisional Ser. No. 60/848,331, filed Sep. 28, 2006, entitled “Method for Generating Custom Postage as part of a Fundraising Event”, U.S. patent application Ser. No. 11/168,651, filed Jun. 27, 2005, entitled “Method for Generating Custom Postage Stamps”, and U.S. patent application Ser. No. 11/396,895, filed Apr. 3, 2006 entitled “Method for Generating Custom Postage as part of a Fundraising Event”. The disclosures of the above mentioned, commonly owned U.S. patent applications are incorporated by reference herein in their entirety.

### FIELD OF THE INVENTION

The present invention is directed to a carrier including a portion having seeds disposed therein or thereon and, in particular, a biodegradable carrier having seeds that is customized to a particular organization for conducting a fundraiser, or a cause associated with the fundraiser.

### BACKGROUND OF THE INVENTION

Institutions such as schools, churches, charities, affinity groups and the like often use fundraising activities to generate the capital needed to offer services or even to continue in existence. These activities typically require a great deal of planning and time to implement. In addition, they are usually “one-time” activities wherein a continuous revenue stream stemming therefrom is not realizable. In addition, these fundraising activities often have limited appeal to large population segments. Moreover, they can be logistically cumbersome as the items sold are sometimes perishable and must be gathered in a common location for distribution or to be picked up. Furthermore, the items offered for sale as part of a fundraiser are sometimes large and consume a great deal of space.

Most fundraisers offer items that are not useable year round on a continuous basis. Accordingly, the need to replenish such items is minimal. In addition, it has been historically difficult for groups to maintain a sustained year-round fundraising effort. Personnel and other logistical considerations make an ongoing campaign difficult. This is particularly true where the personnel conducting the fundraising activity consist of volunteers who may have competing obligations.

There is a current need to provide a reusable classification of items that can be customized for a fundraising effort, has wide appeal to contribute to the success of the fundraising effort, and where the classification of items is one that most people will have an ongoing need to use such that the fundraising effort is sustainable for a prolonged period of time. Moreover, the inventor has discovered that the classification of items offered for sale must be something that will catch the attention of potential purchasers by, for example, being personalized, delivering a good feeling and/or having meaning specific to the particular group.

### SUMMARY OF THE INVENTION

The present invention resides in one aspect in a carrier for use in conducting a fundraiser. The carrier including a first layer having a plurality of seeds disposed therein or thereon, a second layer disposed over the plurality of seeds and at least a portion of the first layer, and customizable postage indicia disposed on the first layer. The plurality of seeds and the customizable postage indicia have relevance to the fundraiser.

In one embodiment, the first layer is comprised of a biodegradable material that gradually disintegrates when exposed to moisture. For example, the biodegradable material may be comprised of a paper-based material. In one embodiment, the plurality of seeds is interwoven with paper fibers within a structure of the paper-based material.

In one aspect of the invention, when the biodegradable material disintegrates the plurality of seeds germinate over time and develop into a desired organic matter. In one embodiment, the desired organic matter includes at least one of plants bearing flowers, fruit, vegetables, herbs, trees and the like.

In yet another embodiment, the second layer is removably attached to the first layer by means of an adhesive. The second layer may be removed and the carrier disposed in soil such that the seeds germinate into the desired organic matter.

In still another embodiment, the carrier is suitable for mailing as at least one of a card, envelope, box, package and media affixed to at least one of the card, envelope, box and package. As such, the customizable postage indicia include an appropriate amount of postage for an article of mail and at least one of images, original artwork and combinations thereof. In yet another embodiment, the seeds, the images and the original artwork are at least one of thematic in nature and indicative of a particular season, holiday and social event in keeping with the fundraiser.

In still another aspect of the invention, a method for conducting a fundraiser is presented. The method includes initiating the fundraiser wherein customized pre-paid postcards are offered as part of the fundraiser. The postcards have a plurality of seeds disposed thereon. The method includes creating at least one image to appear on the postcard, the image being at least one of unique to an entity for which the fundraiser is being conducted and, unique to one or more participants in the fundraiser. The method also includes storing an electronic version of the image in a database. The database and software associated therewith, being operable to perform one or more of storing, tracking, and manipulating information relevant to the fundraiser. The method includes receiving orders for the postcards, printing the postcards having the image thereon, and forwarding the postcards to one of an entity for which the fundraiser is being conducted and an entity from which an order was received. In one embodiment, the step of creating at least one image includes at least a portion of participants in the fundraiser creating original artwork for incorporation onto the postcard. In one embodiment, the image forms part of a customized postage indicia disposed on an area of the postcard.

### BRIEF DESCRIPTION OF THE DRAWINGS

The features and advantages of the present invention will be better understood when the Detailed Description of the Preferred Embodiments given below is considered in conjunction with the figures provided.

FIG. 1 is a top, plan view of a carrier having seeds incorporated thereon, in accordance with one embodiment of the present invention;

FIG. 2 is a cross sectional view of the carrier as illustrated in FIG. 1, in accordance with one embodiment of the invention.

In these figures like structures are assigned like reference numerals, but may not be referenced in the description of all figures.

### DETAILED DESCRIPTION OF THE PREFERRED EMBODIMENTS OF THE PRESENT INVENTION

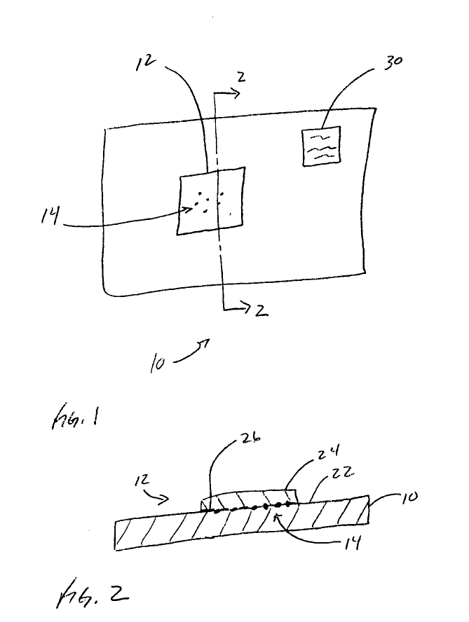

As illustrated in FIG. 1, the present invention is directed to a carrier, shown generally at 10, including a portion 12 having seeds, shown generally at 14, disposed therein or thereon. In one embodiment, the carrier 10 is comprised of a biodegradable material such that when the carrier 10 is exposed to moisture the carrier 10 gradually disintegrates. In accordance with the present invention, as the carrier 10 disintegrates the seeds 14 disposed therein or thereon germinate over a period of time and develop into a desirable organic matter such as, for example, plants bearing flowers, fruit or vegetables, herbs, trees, and the like. In one embodiment, the carrier 10 includes or is comprised of inorganic matter such as, for example, nutrients, enzymes, fertilizers, and the like, to favorably promote the germination process once moisture is introduced. As can be appreciated, the carrier 10 is planted into soil (not shown) to provide a suitable environment for germination and growth of the organic matter.

In one aspect of the present invention, illustrated in FIG. 2, the carrier 10 is comprised of at least two layers 22 and 24. A first layer 22 is comprised of a biodegradable material, as described above, such as, for example, a paper-based product. The seeds 14 are disposed within or on the first layer 22. A second layer 24 is disposed over the seeds 14 and on at least a portion of the first layer 22 to effectively isolate and protect the seeds 14 from an exposure to moisture which may prematurely start the germination process. In one embodiment, the second layer 24 is removably attached to the first layer 22 by means of an adhesive 26. At a desired time, the second layer 24 is removed such that the first layer 22 and the seeds 14 may be exposed to moisture to begin the germination process. For example, the second layer 24 is removed from the first layer 22 before the carrier 10 is planted in the soil.

In one embodiment, the seeds 14 are embedded within the first layer 22. For example, the first layer 22 is comprised of a paper based product and the seeds 14 are interwoven with paper fibers or otherwise incorporated within the structure of the paper based product. In another embodiment, the seeds 14 are disposed on a surface of the first layer 22 and enclosed by the second layer 24.

In one aspect of the invention, the carrier 10 is suitable for mailing as, for example, a card, envelope, box, package, or media such as, for example, a label or the like, that is affixed to such cards, envelopes, boxes or packages. In one embodiment, the carrier 10 includes customized postage indicia 30 corresponding to a particular organization conducting a fundraiser, or a cause associated with the fundraiser. For example, the customized postage indicia 30 includes an appropriate amount of postage for an article of mail as authorized by, for example, the U.S. Postal Service, or other private, governmental or quasi-governmental postal or parcel service within the United States and any other country worldwide. In one embodiment, the customized postage indicia 30 includes images and/or original artwork, or a combination thereof, that may be thematic in nature and/or indicative of a particular season, holiday, or social event, in keeping with the fundraising effort.

In accordance with the present invention, the seeds 14, and the images and/or original artwork in the customized postage indicia 30 have significance relevant to the organization for which the fundraiser is being conducted. For example, if the organization conducting the fundraising effort is an affinity group, such as a university alumni association, the images may include scenes of the relevant university campus. The images can also include logos, sports team images, memorabilia or the like, that is relevant to the university. However, the present invention is not limited in this regard as other images and/or original artwork relevant to the particular organization such as, for example, images of distinguished or famous past or present members of the organization are created without departing from the broader aspects of the present invention. Once the images are created, the organization chooses one or more of the images for inclusion on the customized postage indicia 30. In addition, the present invention also contemplates incorporating other images such as photographs into the customized postage indicia 30. For example, where a school is conducting a fundraising event, a child's school picture, alone or in combination with a class picture or other picture may be incorporated into the customized postage indicia 30.

Additionally, the seeds 14 have significance relevant to the organization for which the fundraiser is being conducted, and/or to the theme that a gift giver wishes to pass along to the receiver, such as, for example, a flower or plant related to a particular season, holiday, or social event, in keeping with the fundraising effort. For example, the gift giver may wish to pass along a romantic greeting by way of the carrier 10 including a romantic message and embedded seeds for growing roses, or pass along well wishes to an ill person by way of the carrier 10 including a get well message and embedded seeds for growing a cheerful flower such as daisies. Similar the organization may be associated with a particular flower, fruit or vegetables, herbs, trees, and the like, and seeds corresponding to the associated flower, fruit, vegetable, herb, tree and the like, is embedded in or on the carrier 10. Accordingly, planting the carrier 10 and seeds 14 provides a means for long term remembrance of the gift and the gift giver.

As described above, the carrier 10, seeds 14 and customized postage indicia 30 are produced and purchased by a participant as part of a fundraising activity. Generally speaking, the fundraising activity lasts a predetermined time period such as, for example, between two and six weeks. During this predetermined time period custom messages, images and/or artwork are created as part of the customizable postage indicia 30 and orders for allotments of carriers 10 are taken from participants. The custom carrier/postage orders are then processed by an approved agent (described in detail in the aforementioned commonly owned U.S. patent applications) and provided to the fundraising activity sponsor (e.g., the organization) or directly to the participant purchasing the order for the carriers 10. Once provided to the participants, the participants use the carriers 10 to, for example, send gifts, greetings, well wishes and the like, to recipients. Upon receipt, the recipients view the greetings and may plant the carrier 10 in soil. Once planted and given appropriate moisture, the seeds 14 disposed on or in the carrier 10 germinate to provide a desired organic plant bearing flowers, fruit or vegetables, herbs, trees, and the like, to serve as a remembrance of the gift, greeting, well wishes, and the like, from the participant to the recipient.

As noted above, one aspect of the present invention resides in supplying customized, prepaid postage on the carriers 10 that are suitable for mailing, have seeds 14 disposed therein or thereon and bearing the above-described original images and/or artwork thereon. It should be appreciated that the images and artwork of the customized postage indicia 30 can be enlarged and cover a substantial portion of a surface of the carriers 10 or it can be of a size akin to a conventional postage stamp and positioned on the carrier 10 where a postage stamp would normally be placed (e.g., in an upper right hand corner of the carrier).

Preferably, the fundraising activity would be conducted as described herein; however, the present invention is not limited in this regard. This embodiment of the present invention contemplates that more than one original artwork or image can be printed onto a carrier 10 within the customized postage indicia 30 or otherwise printed or included on the carrier 10. For example, where a participant has created more than one piece of original artwork, these images can be printed together onto the carrier 10. Moreover, the present invention contemplates two or more persons collaborating to create original artwork, images and the like. The same carrier could include images of the collaborative artwork.

Moreover, the present invention further contemplates incorporating an image or photograph of the artist along with an image of the original artwork that he/she created, on the carrier. While an image of the artist has been described, the present invention is not limited in this regard, as other images or photographs may also be employed. For example where the fundraiser is directed to raising money for an individual medical expense, a photograph of the party benefiting from the needed medical treatment may be provided. Another example could be when a fundraiser is used to raise money for a scholarship bearing an individual's name; a photograph of the individual can be included on the carrier 10 along with other original artwork.

In another aspect of the present invention, a gift-to-donation program is contemplated. In exchange for a charitable contribution, a donor can be given an amount of custom postage (e.g., the custom postage indicia 30). The custom postage can incorporate images created on behalf of an affinity group as described above. The custom postage can also include original artwork created in the above-described manner. The images on the custom postage can also include logos of such things as universities, clubs, sports team and the like.

The particular organization offering the custom postage in exchange for the charitable contribution can do so by pre-purchasing a quantity of the custom postage and, for example, can give a predetermined quantity of custom postage for a particular donation amount. Instead of having a quantity of custom postage on-hand, the particular organization, upon receiving a sufficient donation, can advise the agent producing and/or facilitating the production of the custom postage, to ship a quantity of custom postage to the organization and/or the donor. The donor may be given a choice of images to be printed onto the custom postage. The donor depending on the applicable tax laws, may be able to take a tax deduction on all or a portion of the donation.

In addition to the foregoing, the present invention further contemplates that all or a substantial portion of the above-described donation process can be accomplished electronically. The donor can access a website to make their donation to a respective organization via a credit or debit card, or electronic funds transfer. Once the donation is made the carrier 10 including the seeds 14 and the custom postage indicia 30 relevant to the particular organization can be automatically sent to the donor. If there is a choice of images or original artwork that can be printed onto the custom postage indicia 30, the donor can access this information on the website, make his/her choice of images and then the chosen custom postage can be forwarded to the donor. In order for the donor to access the website to make a donation, the donor can be required to give certain identifying information by entering the information into the appropriate places in the website. This information can be stored in a database along with information relevant to the organization to which the donation was made. The stored information can later be used by the organization to track donors and donations, to contact donors when funds are needed, and the like.

The present invention also resides in a social citizenship program wherein fundraising is conducted on behalf of organizations that provide monetary or other aid to people, populations, or segments of populations in need of financial or other aid. The entity conducting the fundraiser can be a school, church or other entity. The participants, typically children, create original artwork as described above; the artwork can be relevant to the particular cause for which funds are being raised. However, the present invention is not limited in this regard as the artwork can simply be unique to the individual. The original artwork would be created as set forth above and converted into an electronic format, or created electronically. Participants in the fundraiser, once their artwork is created could solicit orders for the carrier 10 including the seeds 14 and the custom postage indicia 30 in the manner described herein above. In addition, the company facilitating the fundraiser can also establish a website or web page accessible via a website through which the carrier 10 or other items bearing artwork can be ordered with at least a portion of the proceeds being donated to the charity.

This embodiment of the present invention also contemplates selecting one or more original artwork images to appear on the custom postage indicia 30, the seeds 14 and the images being relevant to the particular cause for which the fundraiser is being conducted.

In another aspect of the present invention, the facilitating company will establish a website having entertainment and educational components thereto. Access to the website will be allowed upon registration of an original artwork image to be converted into custom postage indicia 30. However, the present invention is not limited in this regard as access to the website may be gained in other manners, such as, but not limited to being listed or registered as a participant in a fundraising event, the participant/registrants identifying information being stored in the above-described database.

Although this invention has been shown and described with respect to the detailed embodiments thereof, it will be understood by those of skill in the art that various changes may be made and equivalents may be substituted for elements and steps thereof without departing from the scope of the invention. In addition, modifications may be made to adapt a particular situation to the teachings of the invention without departing from the essential scope thereof. Therefore, it is intended that the invention not be limited to the particular embodiments disclosed in the above detailed description, but that the invention will include all embodiments falling within the scope of the above description.

What is claimed is:

1. A carrier for use in conducting a fundraiser, said carrier comprising:
a first layer having a plurality of seeds disposed therein or thereon;
a second layer disposed over the plurality of seeds and at least a portion of the first layer; and
customizable postage indicia disposed on the first layer;
wherein the plurality of seeds and the customizable postage indicia have relevance to the fundraiser.

2. The carrier of claim 1, wherein the first layer is comprised of a biodegradable material that gradually disintegrates when exposed to moisture.

3. The carrier of claim 2, wherein the biodegradable material is comprised of a paper-based material.

4. The carrier of claim 3, wherein the plurality of seeds are interwoven with paper fibers within a structure of the paper-based material.

5. The carrier of claim 2, wherein when the biodegradable material disintegrates the plurality of seeds germinate over time and develop into a desired organic matter.

6. The carrier of claim 5, wherein the desired organic matter includes at least one of plants bearing flowers, fruit, vegetables, herbs, trees and the like.

7. The carrier of claim 1, wherein the second layer is removably attached to the first layer by means of an adhesive.

8. The carrier of claim 1, wherein the carrier is suitable for mailing as at least one of a card, envelope, box, package and media affixed to at least one of the card, envelope, box and package.

9. The carrier of claim 1, wherein the customizable postage indicia includes an appropriate amount of postage for an article of mail and at least one of images, original artwork and combinations thereof.

10. The carrier of claim 9, wherein the seeds, the images and the original artwork are at least one of thematic in nature and indicative of a particular season, holiday and social event in keeping with the fundraiser.

11. A method for conducting a fundraiser, comprising:
initiating the fundraiser wherein customized pre-paid postcards are offered as part of the fundraiser, the postcards having a plurality of seeds disposed thereon;
creating at least one image to appear on the postcard, the image being at least one of unique to an entity for which the fundraiser is being conducted and, unique to one or more participants in the fundraiser;
storing an electronic version of the image in a database, the database and software associated therewith, being operable to perform one or more of storing, tracking, and manipulating information relevant to the fundraiser;
receiving orders for the postcards;
printing the postcards having the image thereon; and
forwarding the postcards to one of an entity for which the fundraiser is being conducted and an entity from which an order was received.

12. The method as defined by claim 11 wherein the step of creating at least one image includes at least a portion of participants in the fundraiser creating original artwork for incorporation onto the postcard.

13. The method as defined by claim 11 wherein the image forms part of a customized postage indicia disposed on an area of the postcard.
